(19) United States
(12) Patent Application Publication
(10) Pub. No.: US 2006/0253858 A1
(43) Pub. Date: Nov. 9, 2006

(54) Software service application and method of servicing a software application

(75) Inventors: Donn Rochette, Fenton, IA (US); Craig MacDonald, Kanata (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Trigence Corp., Ottawa (CA)

(21) Appl. No.: 11/415,028

(22) Filed: May 1, 2006

Related U.S. Application Data
(63) Continuation-in-part of application No. 11/380,285, filed on Apr. 26, 2006.
(60) Provisional application No. 60/678,721, filed on May 6, 2005.

(51) Int. Cl. G06F 9/46; G06F 9/44

(52) U.S. Cl. 719/313; 719/319

(57) ABSTRACT

A system and a method are disclosed within an operating system (OS) environment, having an OS and a software application requesting a service. The invention disclosed fulfills requested services by filtering requests and fulfilling certain types of requests in an unconventional, atypical manner. For example a service call, such as an “open call” is executed through an additional software application which is not provided by the operating system or the software application which requests the service. The additional software application provides file or object mapping information or file or object mapping services for the requested service to obtain an address or pointer from a plurality of file or object name spaces; and, provides an address or address pointer from the one or more software service applications of one or more files or objects required to execute the service, and passing said address or pointer to one of the OS libraries that would have otherwise serviced that request or to the kernel in the absence of said address or pointer from the one or more software service applications.

### CROSS-REFERENCE TO RELATED APPLICATIONS

This application claims priority of U.S. Provisional Patent Application Ser. No. 60/678,721 filed May 6, 2005, and is a continuation in part application of U.S. patent application Ser. No. 11/380,285 filed Apr. 26, 2006, entitled “System Including Run-Time Software To Enable A Software Application To Execute On An Incompatible Computer Platform”, which are incorporated herein by reference for all purposes.

### FIELD OF THE INVENTION

The invention relates to computer software, and in particular, the invention relates to management of one or more software applications for providing containment of information.

### BACKGROUND OF THE INVENTION

When software applications installed on a computer platform require services from the kernel they make a system call by way of example, an “open” call, operating system (OS) libraries in user mode, installed on the computer platform along with the kernel in kernel mode, service such requests or system calls.

This invention relates to establishing relative independence of an installed software application from the local OS. This independence is fundamental to an ability to manage an application as an independent object.

The current state of the art requires that an application be managed through manipulation of the infrastructure used to enable the application; primarily but not limited to the underlying OS, upon which the application resides. Application management includes, for example, activities such as, deploying, monitoring, maintaining and extending an application.

It is preferable and more effective if an application could be managed independent of the infrastructure employed to host the application. This would allow an application to be deployed independent of the OS. In fact, it would be desirable for an application to be deployed into a number of different OS variants. Once deployed an independently managed application could be monitored to the extent that processes and resource utilization could be discovered and reports generated independent of an OS. Furthermore, an independently managed application could be updated and extended by applying changes that affect the application and do not affect an underlying OS.

In order to manage and interact with an application as an independent entity it would be necessary create an environment where the application could access any files or objects that it needs to execute distinct from the underlying OS. As a software application executes within such an environment it makes use of files independent of the underlying operating system (OS) and independent of other applications hosted on the same compute platform. The result is creation of a unique application file set, which is part of what enables the application to become independent of the underlying infrastructure. This unique application file set would include files specific to the software application as well as any files utilized by the application from an OS.

There are a number of methods that can be employed to create and manage a unique application specific file set. Several commercial systems based on a UNIX operating system (OS) deliver similar behavior by using the ‘chroot’ system call. The chroot system call allows an alternate root directory to be specified; thereby globally rerouting calls to a particular file name space. This alternate root becomes the basis for all file references made by applications for which chroot has been configured. While use of “chroot” in this manner can serve to create a unique file name space it has a number of drawbacks. It is relatively simple to break out of the confines of the alternate root directory and access other files. Moreover, it is cumbersome to utilize individual files from multiple file name spaces. Where it would be desirable, for example, to allow one file to exist in a shared name space while another exists in a private name space this would be quite difficult to accomplish on any scale through the use of an alternate root directory.

Capsule file mapping, as described in accordance with this invention, facilitates the use and management of a unique software application file set.

It is an object of this invention to provide a method of servicing requests from an installed application whereby some independence and isolation from the underlying operating system is provided. The independence between an application and an underlying OS, afforded through the use of servicing specific requests from an application, is fundamental to enabling interaction with an application as an independent entity.

### SUMMARY OF THE INVENTION

In accordance with this invention, in a system having an operating system (OS) including application libraries resident in user mode and having a kernel resident in kernel mode, wherein a software application requesting a service from one of the application libraries is reliant on the kernel to execute the service, a method is disclosed for providing the service comprising the steps of:

providing one or more software service applications which are not provided by the OS or the software application, which provides file or object mapping information or file or object mapping services for the requested service to obtain an address or pointer from a plurality of file or object name spaces;

providing an address or address pointer from the one or more software service applications of one or more files or objects required to execute the service, and passing said address or pointer to one of the OS libraries that would have otherwise serviced that request or to the kernel in the absence of said address or pointer from the one or more software service applications.

In accordance with another aspect of the invention there is provided, a software service application for filtering a predetermined type of requested service call received from a first software application made to an operating system library resident on a computer platform having an operating system (OS) including application libraries resident in user mode and having a kernel resident in kernel mode, the filtering software application comprising:

means for determining if a service call from the first software application is the predetermined type of service call; and

means for providing file or object mapping information or file or object mapping services to obtain an address or pointer from a plurality of file or object name spaces to an object or file required to execute the service.

By way of example, types of service calls that fall within the predetermined type of call are: Inclusive:

System service calls that operate on directory listings; system service calls that access files;

system service calls that access file meta-data (i.e. information about the file as opposed to information contained in the file; for example file status); and, system service calls that use labels to access objects used for Inter-Process Communication.

Examples of system service calls that are not handled by the special filter and that are handled the “typical” way by the application and the OS are: system service calls that create and/or remove processes; system service calls that read and/or write information to/from files; and,

system service calls that perform creation, deletion and/or management of threads.

### BRIEF DESCRIPTION OF THE DRAWINGS

FIG. 1 is a flow diagram illustrating aspect of the invention in conjunction with an application and an Operating System (OS).

FIG. 2 is a flow diagram illustrating that a filtered request for a specific file can be satisfied from of a number of possible physical locations.

FIG. 3 is a diagram which shows one embodiment of the invention wherein Meta data is used to map a given file.

FIG. 4 is a flow chart showing the operation of the invention in one embodiment using file Meta data.

FIG. 5 is a diagram illustrating how and identifier associated with a file set is translated to a pathname defining the location of the file set.

FIG. 6 is a block diagram of on embodiment of the invention using “search order” to map a file to one of several possible file name spaces.

FIG. 7 is a diagram illustrating the control elements used in one embodiment of the invention to manage a search order for resolving request for a specific file.

FIG. 8 is a diagram illustrating creation of a super block from an application specific file set.

### DETAILED DESCRIPTION

An application capsule which will be described in greater detail hereafter provides a mechanism that enables the state of a software application to be kept local to the application, independent of the underlying infrastructure and other applications. Application capsules accomplish this task by isolating both static application state and dynamic application state. In most cases, static application state is persistent and managed in various files. Dynamic application state often times includes values assigned to the application by OS services as processes execute.

In accordance with an aspect of this invention, each software application capsule provides/supports its own unique file namespace or hierarchical file system.

In UNIX based systems a similar but more restrictive type of functionality is often times provided by the chroot system call. The chroot system call allows one to change the root directory to a specified path, which then becomes the root directory for that process and any children processes. This provides the basic unique file namespace requirement but additional functionality is required to fulfill a capsule model that supports one or more software applications.

Additional features required to support a capsule file system are: application file security that does not include the same limitations as chroot and support for application specific file sets with smaller disk space requirements.

A basic capability is required that allows any single file to be selected from a plurality of sources.

In contrast, prior art solutions allow alternate file mapping rather than allowing the selection to be done on a per file basis. In the prior art, a significant limitation occurs when a root user exits out of a chroot environment.

The capsule file system design in accordance with an aspect of this invention enhances the security of the virtual root environment. Capsules are sometimes more effective where the file set size is minimized to those files required by the application it represents. A smaller application specific file set size requires less time and resources to deploy; copy and expand files into a directory hierarchy, and decreases management overhead; and, does not require that duplicate file copies be maintained.

A minimal application capsule is one that consists of a minimal set of files; only those needed for the application to execute correctly in the capsule. However, it is useful to manage the application in a capsule context as if it was a full OS environment. To allow for this functionality, the additional OS environment files not present in the application file set must be accessible within the application capsule context to any operator or process performing management tasks. Where the intent is to include a minimal set of files in the application file set, only those files required by the application would be included in the application specific file set. However, where maintenance tasks, for example, are accomplished in the context of the application capsule there would be a need to use files and services that are not contained in the minimal application files set. The files not contained in the minimal application file set, additional files from the context of maintenance operations, would need to be accessible from the underlying OS file name space or possibly a shared files set. Additional OS environment files could include, for example, a shell such as bash, a script environment, such as PERL, or any number of OS commands such as change directory or list directory. To make any additional OS environment files available to a process executing the application capsule context the file namespace of the application capsule and the underlying OS environment must be merged into one namespace. To simplify this process the files from the underlying OS are made available to processes executing within the capsule environment. In addition to this, a capsule type known as a shared capsule is provided. Some characteristics of a shared capsule, although not limited thereto, are the collection of a set of files that can be accessed by multiple application capsules. Files embodied in a shared capsule are read-only. That is, any attempt by a process within a capsule context to modify a file in a shared capsule will result in the file being copied from the shared capsule to the application specific file set. A software application capsule when combined with a shared capsule and/or files from the underlying OS will provide a full environment capsule.

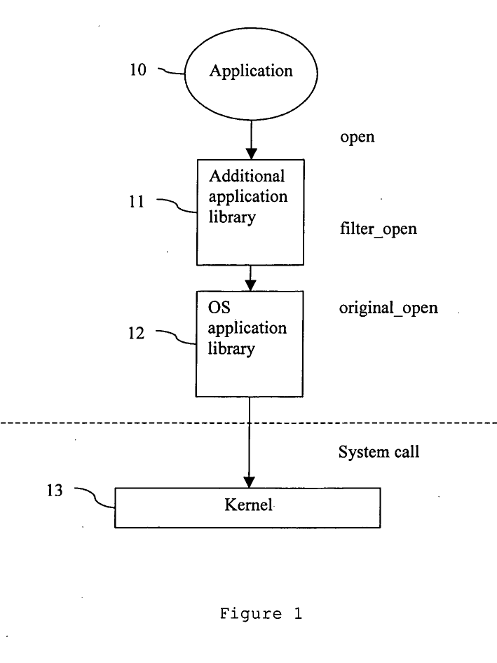

Referring now to FIG. 1, a filter operation is shown inserted in the system service path to enable a file mapping operation. By way of example, a software application 10 installed on a computer platform makes an open call. In practice any system service that operates on a pathname is filtered in a same manner. After the open call, an application library 11 is placed in the same virtual address space as defined by the local OS and used by the software application 10. The filter is embodied within the additional application library 11. The filter corresponding to the open command performs additional processing before invoking the original service “open” in the OS application library 12 that would have otherwise handled the open request from the application 10 in the absence of the additional application library 11 being present. The original service is embodied in an application library 12 supplied by the local OS. The system service is ultimately made to the kernel 13 through the use of a system call as defined by the local OS.

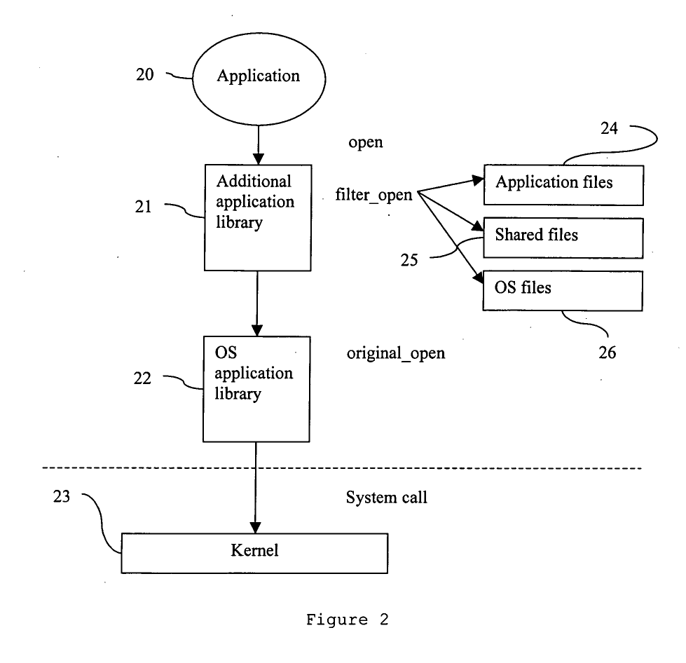

FIG. 2 extends the filter operation by introducing multiple possible sources 24, 25 and 26 for a file. Services that use a path name from application 20 are filtered as shown in 21. The filter operation within the additional software library 21 locates the file requested by the application 20 from one of a plurality of sources 24, 25 or 26. The result is that the filter operation in 21 uses a path name that is different from that passed from the application 20 when the filter 21 makes the original service call 22. The original service is passed to the kernel 23 using a system call as defined by the OS. The use of an alternate path name, where the alternate pathname points to one of the plurality of sources 24, 25 or 26, instead of the original path name passed by the application 20 enables file mapping in support of capsule operation. This mapping is transparent to the application 20.

Two of several mechanisms employed to enable the mapping of an original path name to one from a plurality of sources are presented. The first embodiment uses meta-data to map file requests. This has the advantage of being fast; not imposing undue additional performance overhead. The use of meta-data has the disadvantage of requiring considerable disk space. The second embodiment uses a search order mechanism to map file requests. A search order has the advantage of requiring minimal disk space; however has the disadvantage of requiring slightly more processing overhead.

A file mapping capability based on meta-data stores information about each file in an OS defined directory hierarchy. Referring now to FIG. 2, each file from a plurality of sources 24, 25 or 26 has a corresponding file that contains meta-data information. The meta-data file contains information used to describe the actual location of the real file.

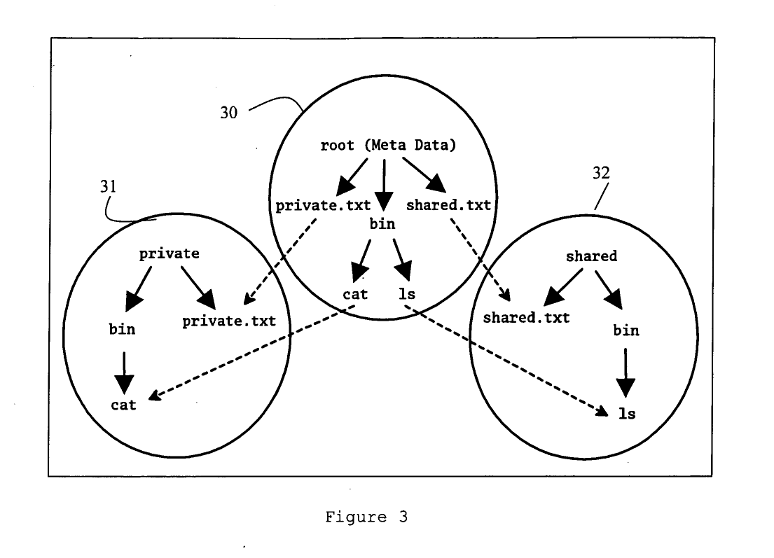

The meta-data file can be viewed in analogous form to an enhanced symbolic link. Both contain a file pointer, but the meta-data file contains additional values as can be seen in FIG. 3. By way of example, meta-data 30 contains information describing the files private.txt, shared.txt, /bin/cat and /bin/ls. Two sources of files are shown 31 and 32. A private set of files 31 contain private.txt and /bin/cat. A shared set of files 32 contain shared.txt and /bin/ls. Meta-data 30 is used by a filter operation to direct that access to the file/bin/cat located within the private source 31. If the requested file, e.g. /bin/cat, is not present in the set of files defined by the private content 31 the request will fail.

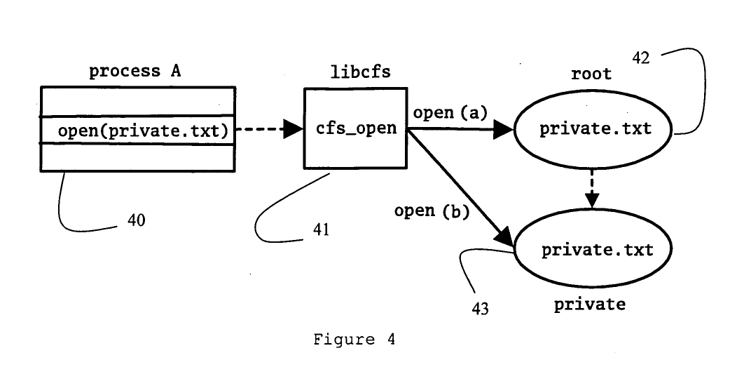

With reference to FIG. 4 when a process that uses system service filters 40 attempts to access, for example, the file private.txt, the filter 41 resident in an application library 41 performs a first open (a) of a meta-data file 42 to determine which one of a plurality of sources should be utilized to locate the file. In the example shown in FIG. 4 the meta-data file 41 points to the file set named private 43. A second open (b) is performed by the filter 41 to access the file private.txt from the files set indicated as private 43.

In order to create a standard file system view, the meta-data files must be invisible to processes executing in a capsule context. This is accomplished by filtering system services which directly operate on pathnames. This is illustrated, by way of example, in FIG. 4; when a process 40 opens a file, the open system call is redirected to the cfs_open function 41. The cfs_open function 41 first combines the pathname argument with the known pathname to the root meta-data directory to open the meta-data file 42. The meta-data file is read and parsed to determine where the physical file to be used is located. The physical file from private file space 43 is then opened and the file descriptor is returned to the original process 40. The process 40 is unaware of the existence of the meta-data file; its open call returns a file descriptor for the desired pathname, even though the true location of the file being used is in a different path location.

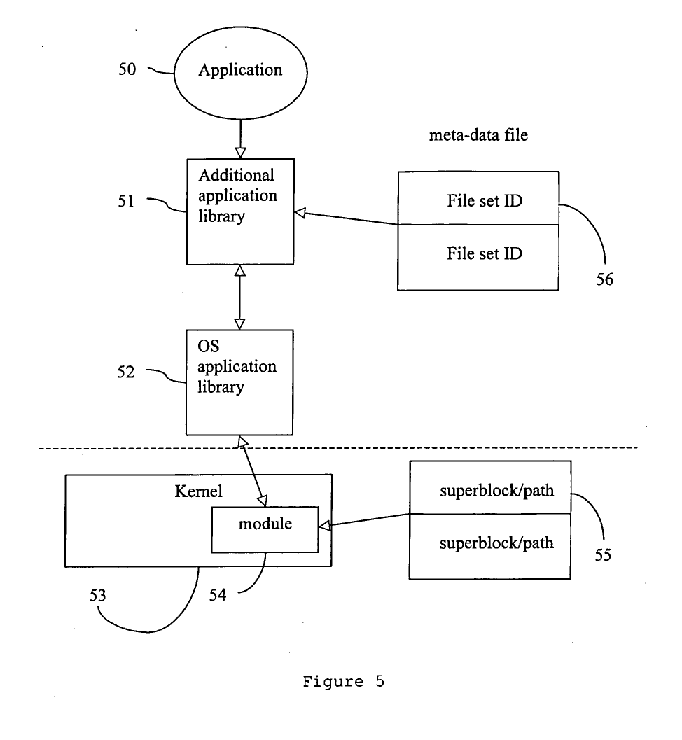

As previously described, a filter is applied to any system service using a pathname argument. This filter operation merges the meta-data file path location with the original argument pathname to produce the full pathname to be used. The information stored in a meta-data file is not a pathname, but a file set ID. Each defined file set has a unique path offset location which represents an entry in the local OS file namespace. These path names represent one of a plurality of file sets that can be used to satisfy a request for a specific file. As shown in FIG. 5 the capsule runtime kernel module 54 stores this file set ID/file path offset relationship 55 for each defined file set. Therefore, the pathname given to the kernel module 54 is the file set ID plus the pathname of the file set. When a file set is defined the ID and the pathname for the file set are provided to the kernel module 54. A software application 50 installed on the computer platform is used to create a file set. The application 50 makes a call to the OS supplied application library 52 in order to communicate to the kernel module 54. A system call is made from the application library 52 to the kernel 53. A device driver interface is used by the kernel 53 to pass information to the kernel module 54.

In an embodiment of the invention using meta-data as a means to locate a specific file, the information retrieved from a meta-data file 56 is a file set ID. The ID 56 must be passed by the filter 51 to the kernel module 54 for translation to a pathname. The kernel module 54 checks to see if the ID and the pathname are valid and if it is, replaces the capsule ID with its corresponding pathname and returns the pathname value to the additional application library 51. The final pathname used for the system service, is a pathname offset to a file set plus the original argument pathname. If a capsule ID is not valid, the filter returns with an error code. This will, for example, stop a user mode process from manipulating a user-space debugger to change a pathname argument to another pathname outside of the capsule file namespace.

The services defined in this invention to locate files are extended to include the ability to copy a file from one file set namespace into another. This copy is performed in the context of the running process. The copied file, by default, has the same file ownership and permissions as defined by the underlying OS as the original file. It is possible that the current process will not have the privileges to set the correct owner and permissions on the copied file. A external program, such as a UNIX defined setuid copy program is used to perform the copy and ensures proper file permissions.

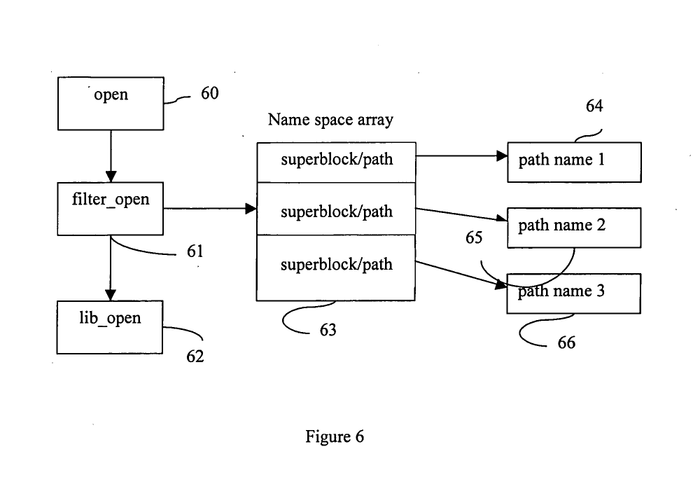

In an alternate and preferred embodiment of the invention a search method is used to locate and retrieve files instead of the aforedescribed meta-data method. The mechanisms depicting the search method are shown in FIG. 6. In operation, the installed software application 60 invokes a system service call that requires a pathname, for example an “open” call. A filter 61 is installed such that the filter is called before the application library service 62. The filter 61 references a namespace array 63. The name space array 63 contains a super block and a pathname. The super block 63 defines the file set ID and other optional parameters associated with a specific file set. The pathname 63 describes the starting point of a specific file set 64, 65 or 66. When an application 60 requests access to a specific file the filter 61 examines the contents of the namespace array 63. The filter 61 then attempts to locate a file by concatenating the pathname provided by the application 60 to the pathname of a file set 64, 65 or 66 as defined in the namespace array 63. Each entry in the namespace array is referenced as described until the file is located. If the file is not located in any defined file set an error is returned from the filter 61 to the application 60. For example, an application 60 opens the file /lib/libc. The filter 61, in one embodiment of the invention, will access pathname values from a name space array 63. Each pathname defined in the name space array 63 is referenced to determine if the file libc is present. If the first entry, for example, in the namespace array 63 is /export/capsules/foo then the pathname /export/capsules/foo, is concatenated with the path requested by the application 60, /lib/libc. The filter 61 will attempt to access the file /export/capsules/foo/lib/libc. If the file libc is present in the location /export/capsules/foo/lib/ then the search is complete. The pathname /export/capsules/foo/lib/libc is passed to the orginal system service in the application library 62. The lib_open function embodied in the application library 62 makes a system call using the modified pathname /export/capsules/foo/lib/libc. If the file is not present the search continues with the next entry in the namespace array 63. This process is replicated until all entries in the namespace entry 63 have been referenced. If no file is found the filter operation 61 returns an error to the application 60.

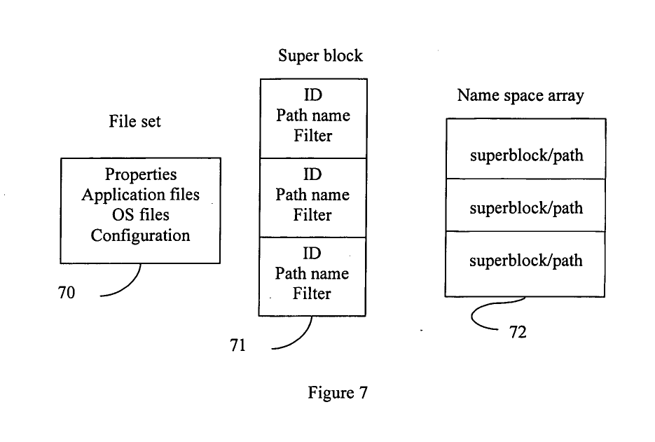

With reference to FIG. 7 the namespace array used by a filter is created from a file set definition 70. The values from a file set definition 70 are communicated to a kernel module in a manner described in FIG. 5. The kernel module creates a super block structure 71. During initialization of filters the super block 71 is communicated to a filter library, creating a namespace array 72.

An application specific file set definition 70 is created by making a copy of the files and objects referenced by an application. These files include those that are specific to the application as well as files from an OS that are referenced by the application. Properties associated with the application can optionally be defined in a file and placed in the application file set. Examples of properties might include application name and unique identifier.

The discovery of files required by a specific application is enabled by a process extended with filters of system services that require the use of a pathname. Such a process can track any files accessed when an application is executed and copy theses files into the application file set. In this manner the complete original file set is saved. The files which were not copied into the application file set will be accessible from other defined file sets. These could include file sets associated with the local OS or a shared file set.

A shared file set is utilized in at least one embodiment of the invention. Shared capsules are, by default, read-only. If an application attempts to modify a file in a shared file set, that file is copied into the applications' private file set. There is the possibility for special case writable files in a shared file set; the default case is to use read-only files.

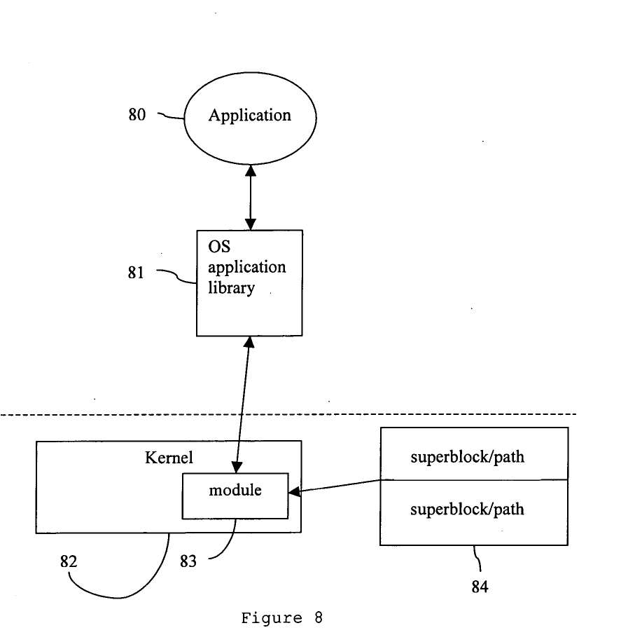

With reference to FIG. 8 once an application specific file set has been defined a super block 84 can be created. A kernel module 83 is embodied in the kernel 82. A creation step, accomplished with an application program 80, results in the creation of a super block entry 84. The pathname defining the location of the application specific file set created in 70 is passed to the kernel module 83 by the creation application 80. The kernel module stores the pathname of the application specific file set 70 in a super block object 84. With reference to FIG. 5 when the additional application library 51 is initialized it requests super block information 55 from the kernel module 54. This super block information is the same information created as a result of the creation application 80.

What is claimed is:

1. In a system having an operating system (OS) including application libraries resident in user mode and having a kernel resident in kernel mode, wherein a software application requesting a service from one of the application libraries is reliant on the kernel to execute the service, a method of providing the service comprising the steps of:
providing one or more software service applications which are not provided by the OS or the software application, which provides file or object mapping information or file or object mapping services for the requested service to obtain an address or pointer from a plurality of file or object name spaces;
providing an address or address pointer from the one or more software service applications of one or more files or objects required to execute the service, and passing said address or pointer to one of the OS libraries that would have otherwise serviced that request or to the kernel.

2. A method as defined in claim 1 wherein the mapping services include searching a plurality of object to file name spaces to locate the address or pointer to the object or file.

3. A method as defined in claim 1 wherein a kernel module is provided for extending services provided by the kernel.

4. A method as defined in claim 3 wherein the kernel module is provided with addresses or pointers to files or objects required by the software application.

5. A method as defined in claim 4 wherein the one or more software service applications are provided with information related to the location of the files or objects from the kernel module.

6. A method as defined in claim 1 wherein the mapping services include meta-data for providing locations of an address or pointer to the object or file.

7. A method as defined in claim 1 wherein the one or more software service applications operates on a subset of system services that use a name as an identifier to locate the requested object or file.

8. A software service application for filtering a predetermined type of requested service call received from a first software application made to an operating system library resident on a computer platform having an operating system (OS) which includes application libraries resident in user modem and a kernel resident in kernel mode, the filtering software application comprising:
means for determining if a service call from the first software application is the predetermined type of service call; and
means for providing the or kernel or one of the application libraries with the file or object mapping information or file or object mapping services to obtain an address or pointer from a plurality of file or object name spaces to an object or file required to execute the service if the service call is the predetermined type of service call.

9. A software service application as defined in claim 8 further comprising means for passing said address or pointer to one of the OS libraries that would have otherwise serviced that request or to the kernel in the absence of said address or pointer from the one or more additional software applications.

10. A system for filtering as defined in claim 8, wherein a service call from the first software application results in additional OS files from an alternate name space to be merged with the file or object in the file or object name spaces containing the address or pointer to the address of the file or object required to execute the service.

11. A system for filtering as defined in claim 8 wherein the predetermined type of service call includes at least one of:
A system service call that operates on one or more directory listings; a system service call that accesses files; and, a system service call that accesses file meta data.

12. A system for filtering as defined in claim 8 wherein the predetermined type of service call includes a system service call that uses labels to access objects for inter-process communication.

13. A system for filtering as defined in claim 8 wherein the predetermined type of service call excludes a system service call that creates or removes process.

14. A system for filtering as defined in claim 8 wherein the predetermined type of service call excludes system service calls that read information from files and or write information to files.

15. A system for filtering as defined in claim 8, wherein the predetermined type of service call excludes system service calls that perform creation, deletion and/or management of threads.
